(19) United States
(12) Patent Application Publication
(10) Pub. No.: US 2024/0020887 A1
(43) Pub. Date: Jan. 18, 2024

(54) CONDITIONAL VARIATIONAL AUTO-ENCODER-BASED ONLINE META-LEARNED IMAGE COMPRESSION

(71) Applicant: Alibaba Damo (Hangzhou) Technology Co., Ltd., Hangzhou (CN)

(72) Inventors: Yan Ye, San Diego, CA (US); Wei Jiang, San Mateo, CA (US); Wei Wang, San Mateo, CA (US)

(21) Appl. No.: 18/220,795

(22) Filed: Jul. 11, 2023

Related U.S. Application Data
(60) Provisional application No. 63/390,281, filed on Jul. 18, 2022.

(51) Int. Cl. G06T 9/00

(52) U.S. Cl. CPC G06T 9/002

(57) ABSTRACT

An Online Meta Learning (“OML”) framework is provided for learned image compression (“LIC”) based on a variable-rate Conditional Variational Auto-Encoder (“CVAE”) architecture. A computing system is configured to learn, from multiple training tasks of compression with different RD tradeoff λs, a set of task-general meta parameters controlled by meta-control variables Λ. Meta parameters learn a mapping between the meta-control variables Λ and compression effects of different RD tradeoffs λs. Meta-control variables Λ are adaptively determined and transmitted on the fly to an encoder and a decoder of an image compression process, to accommodate the current compression need for any current test datum. A parallelized context computation method is also provided for an online CVAE-based meta-LIC architecture; since OML requires multiple iterations at an encoder, parallel context estimation substantially improves computational time in practice.

### RELATED APPLICATIONS

This application claims the benefit of U.S. Patent Application No. 63/390,281, entitled “CONDITIONAL VARIATIONAL AUTO-ENCODER-BASED ONLINE META-LEARNED IMAGE COMPRESSION” and filed Jul. 18, 2022, which is expressly incorporated herein by reference in its entirety.

### BACKGROUND

In 2022, working group 1 of the coding of audio, picture, multimedia and hypermedia information subcommittee of the ISO/IEC Joint Technical Committee (“ISO/IEC JTC 1/SC 29/WG 1”) and ITU-T Study Group 16 (“ITU-T SG16”) are convening to review proposals for JPEG AI, a new learning-based coding standard for images. Machine learning tools will be incorporated into this new standard to achieve further improvements in compression efficiency over prior standards such as JPEG, JPEG2000, as well as intra-frame coding used in video coding standards such as H.264/AVC (Advanced Video Coding) and H.265/HEVC (High Efficiency Video Coding), and, most recently, Versatile Video Coding (“VVC”). Furthermore, learning-based coding will most likely be a part of future video coding standards succeeding VVC as well.

Present image coding techniques are primarily based in lossy compression, based on a framework including transform coding, quantization, and entropy coding. For many years, lossy compression has achieved compression ratios which are suited to image capture and image storage at limited scales. However, computer systems are increasingly configured to capture and store images at much larger scales, for applications such as surveillance, streaming, data mining, and computer vision. As a result, it is desired for future image coding standards to achieve even smaller image sizes without greatly sacrificing image quality.

Machine learning has not been a part of past image coding standards, whether in the compression of still images or in intra-frame coding used in video compression. As recently as the VVC standardization process from 2018 to 2020, working groups of the ISO/IEC and ITU-T reviewed, but did not adopt, learning-based coding proposals. There remains a need to improve image compression techniques by designing novel machine learning techniques which further improve the balance of image quality and image size, while also improving the computational efficiency of image coding.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a block diagram of an image compression process in accordance with a variety of image coding techniques.

FIGS. 2A and 2B illustrate flow diagrams of an encoder-side learning process according to example embodiments of the present disclosure for a variable-rate meta-LIC based on parallel context estimation.

FIG. 3 illustrates a flow diagram of a decoder-side test stage workflow according to example embodiments of the present disclosure.

FIG. 4 illustrates an encoder having inputs for optimized meta-control variables according to example embodiments of the present disclosure.

FIG. 5 illustrates a decoder having inputs for optimized meta-control variables according to example embodiments of the present disclosure.

FIG. 6 illustrates a hyperprior and context computation module of an encoder according to example embodiments of the present disclosure.

FIG. 7 illustrates a hyperprior and context computation module of a decoder according to example embodiments of the present disclosure.

FIG. 8 illustrates an example system for implementing the processes and methods described herein for implementing an online CVAE-based meta-LIC architecture.

### DETAILED DESCRIPTION

Example embodiments of the present disclosure provide learned image compression (“LIC”) techniques implemented to be compatible with image compression according to the JPEG AI image coding standard, as well as intra-frame coding according to video coding standards.

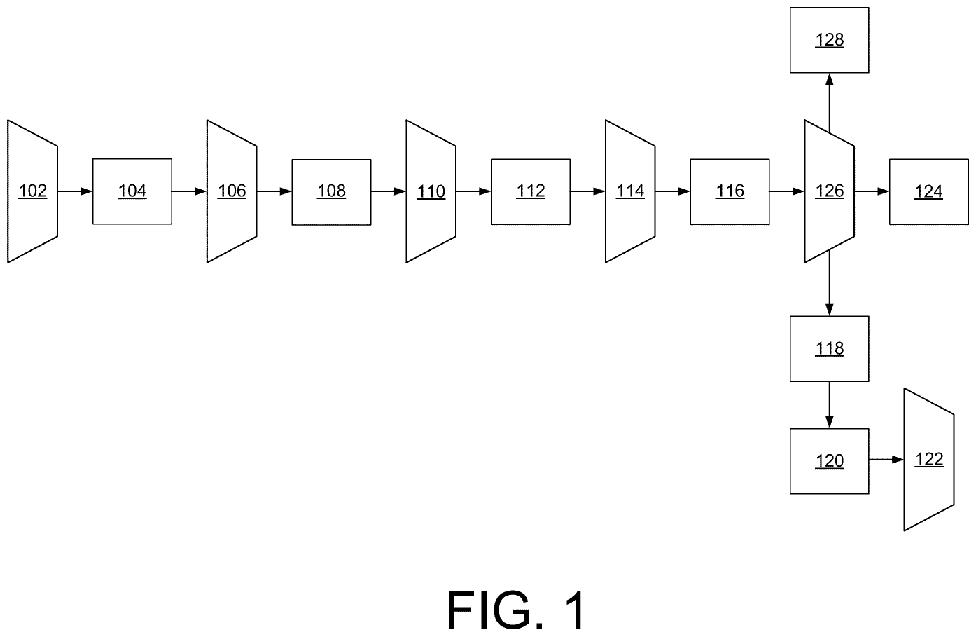

FIG. 1 illustrates a block diagram of an image compression process 100 in accordance with a variety of image coding techniques, such as those implemented by JPEG, JPEG2000, and all JPEG AI proposals, as well as a variety of intra-frame coding techniques, such as those implemented by AVC, HEVC, and VVC. The image compression process 100 can include lossless steps and lossy steps.

It should be understood that the image compression process 100, while conforming to each of the above-mentioned standards (and to other image coding standards or techniques based on image compression, without limitation thereto), does not describe the entirety of each of the above-mentioned standards (or the entirety of other image coding standards or techniques). Furthermore, the elements of the image compression process 100 can be implemented differently according to each of the above-mentioned standards (and according to other image coding standards or techniques), without limitation.

According to an image compression process 100, a computing system is configured by one or more sets of computer-executable instructions to perform several operations upon an input picture 102. First, a computing system performs a transform operation 104 upon the input picture 102. Herein, one or more processors of the computing system transform picture data from a spatial domain representation (i.e., picture pixel data) into a frequency domain representation by a Fourier transform computation such as discrete cosine transform (“DCT”). In a frequency domain representation, the transformed picture data is represented by transform coefficients 106.

According to an image compression process 100, the computing system then performs a quantization operation 108 upon the transform coefficients 106. Herein, one or more processors of the computing system generate a quantization index 110, which stores a limited subset of the color information stored in picture data.

A computing system then performs an entropy encoding operation 112 upon the quantization index 110. Herein, one or more processors of the computing system perform a coding operation, such as arithmetic coding, wherein symbols are coded as sequences of bits depending on their probability of occurrence. The entropy encoding operation 112 yields a compressed picture 114.

One or more processors of a computing system are further configured by one or more sets of computer-executable instructions to perform several operations upon the compressed picture 114 to output the compressed picture.

For example, according to some image coding standards, a computing system performs an entropy decoding operation 116, a dequantization operation 118, and an inverse transform operation 120 upon the compressed picture 114 to output a reconstructed picture 122. By way of example, where a transform operation 104 is a DCT computation, the inverse transform operation 120 can be an inverse discrete cosine transform (“IDCT”) computation which returns a frequency domain representation of picture data to a spatial domain representation.

However, a decoded picture need not undergo an inverse transform operation 120 to be used in other computations. According to the JPEG AI standard, one or more processors of a computing system can be configured to output the compressed picture 114 in formats other than a reconstructed picture. Prior to performing an inverse transform operation 120, or instead of performing an inverse transform operation 120, one or more processors of the computing system can be configured to perform an image processing operation 124 upon a decoded picture 126 yielded by the entropy decoding operation 116.

By way of example, one or more processors of the computing system can resize a decoded picture, rotate a decoded picture, reshape a decoded picture, crop a decoded picture, rescale a decoded picture in any or all color channels thereof, shift a decoded picture by some number of pixels in any direction, alter a decoded picture in brightness or contrast, flip a decoded picture in any orientation, inject noise into a decoded picture, reweigh frequency channels of a decoded picture, apply frequency jitter to a decoded picture, and the like.

Prior to performing an inverse transform operation 120, or instead of performing an inverse transform operation 120, one or more processors of the computing system can be configured to input a decoded picture 126 into a learning model 128. One or more processors of a computing system can input the decoded picture 126 into any layer of a learning model 128, which further configures the one or more processors to perform training or inference computations based on the decoded picture 126.

According to the JPEG AI standard, a computing system can perform any, some, or all of outputting a reconstructed picture 122; performing an image processing operation 124 upon a decoded picture 126; and inputting a decoded picture 126 into a learning model 128, without limitation.

Given an image compression process 100 in accordance with a variety of image coding techniques as described above, learning-based coding can be incorporated into the image compression process 100. Learned image compression (“LIC”) architectures generally fall into two categories: hybrid coding, and end-to-end learning-based coding.

End-to-end learning-based coding generally refers to modifying one or more of the steps of the overall image compression process 100 such that parameters learned by one or more learning models. Separate from the image compression process 100, on another computing system, datasets can be input into learning models to train the learning models to learn parameters to improve the computation and output of results required for the performance of various computational tasks.

By way of example, LIC is implemented by a Variational Auto-Encoder architecture (“VAE”), which further includes an encoder f_{φ}(x), a decoder g_{θ}(z), and a quantizer q(y). x is an input image, y=f_{φ}(x) is a latent representation, z=q(y) is a quantized and encoded bitstream (e.g., through lossless arithmetic coding) for storage and transmission. Since the deterministic quantization is non-differentiable with regard to network parameters φ and θ, the additive uniform noise is generally used to optimize an approximated differentiable rate distortion (“RD”) loss, as described in Equation 1 below:

$${min}_{φ , θ} {E}_{p ( x ) {p}_{φ} ( Z \vert x )} [ λ D ( x , {g}_{θ} ( z ) ) + R ( z ) ]$$

where p(x) is the probability density function of all natural images, D(x, g_{θ}(z)) is a distortion loss (e.g., mean-square error (“MSE”) or mean absolute error (“MAE”)) between the original input and the reconstruction, R(z) is a rate loss estimating the bitrate of the encoded bitstream, and λ is a hyperparameter that controls the optimization of the network parameters to trade off reconstruction quality against compression bitrate. In general, for each target value of λ, a set of model parameters φ and θ needs to be trained for the corresponding optimization of Equation 1.

A learning model can include one or more sets of computer-readable instructions executable by one or more processors of a computing system to perform tasks that include processing input and various parameters of the model, and outputting results. A learning model can be, for example, a layered model such as a deep neural network, which can have a fully-connected structure, can have a feedforward structure such as a convolutional neural network (“CNN”), can have a backpropagation structure such as a recurrent neural network (“RNN”), or can have other architectures suited to the computation of particular tasks. Generally, any layered model having multiple layers between an input layer and output layer is a deep neural network (“DNN”).

Tasks can include, for example, classification, clustering, matching, regression, semantic segmentation, and the like. Tasks can provide output for the performance of functions supporting computer vision or machine vision functions, such as recognizing objects and/or boundaries in images and/or video; tracking movement of objects in video in real-time; matching recognized objects in images and/or video to other images and/or video; providing annotations or transcriptions of images, video, and/or audio in real-time; and the like.

DNNs have been commonly proposed to build a LIC architecture compatible with various implementations of an image compression process 100. Thus, in an image compression process 100 running on a computing system, the various operations of an image compression process 100 are modified by incorporating parameters learned by a DNN during training, which can be performed by a different computing system. DNN-based LIC architectures are, however, limited in several respects.

For example, whereas DNN-based LIC architectures can optimize RD loss for a single compression rate, they face greater challenges in optimizing for multiple compression rates, as it is desired to enable variable compression rate in such architectures. The optimization of RD loss serves to balance a compression model between the reconstruction quality and the bitrate through the RD loss. The tradeoff hyperparameter λ controls the desired compression effect. Training one model instance for each tradeoff λ not only is inefficient, but also makes flexible rate-control impossible, since it is infeasible to train one model for every possible λ value.

In DNN-based LIC architectures, furthermore, soft approximate quantization in training and the true hard quantization at test time are mismatched. Therefore, DNN-based LIC suffers from not only mismatch between the training and test data distributions, but also mismatched training and test quantization methods.

In DNN-based LIC architectures, additionally, sequential autoregressive context computation bears extremely high time cost in both encoder and decoder. Removing this context estimation for speeding up the process has been shown to cause significant performance drop.

Therefore, according to example embodiments of the present disclosure, an Online Meta Learning (“OML”) framework is provided for LIC based on a variable-rate Conditional Variational Auto-Encoder (“CVAE”) architecture.

In a CVAE architecture, the variable-rate LIC configures one or more processors of a computing system to perform VAE-based LIC conditioned on the compression rates controlled by with an RD loss according to Equation 2 as follows:

$${min}_{φ , θ} {E}_{p ( x ) {p}_{φ} ( Z \vert x )} [ λ D ( x , {g}_{θ} ( z ) ) + R ( z ) ]$$

In other words, one set of model parameters φ and θ are optimized for the CVAE network to accommodate the compression needs of a variety of λ conditions.

OML is implemented by a learning model which configures one or more processors of a computing system to perform aspects of both online learning and meta learning. In online learning, the above-mentioned mismatch between training and test data distributions is compensated for during the training process by “online”-updating learned parameters of a trained model. However, such learning techniques perform poorly when applied to DNN training, because highly complex DNN models are trained by batch-based methods using mini-batches, as well as multiple passes over the training data. Updating model parameters on a per-sample basis can be highly unstable.

In meta learning, a set of machine learning tasks are drawn from a task distribution, and a set of training tasks with their corresponding datasets are observed. Then one or more processors of a computing system are configured to learn a task-general prior distribution over the model parameters, and such prior knowledge can be applied to a new task not from among the set, to speed up its learning. Among various meta-learning methods, the gradient-based Model-Agnostic Meta-Learning (“MAML”) has been successfully used in various applications including reinforcement learning and HDR image reconstruction.

OML, in turn, is applied to continual learning, where the task distribution is not fixed but changing over time; MAML meta-training with direct Stochastic Gradient Descent (“SGD”) can be performed online during a task sequence to update the learned model parameters of the task model. However, existing OML frameworks suffer from the same problem of online learning, where online updating the learned parameters based on a single test datum does not perform well for DNN models in general.

According to example embodiments of the present disclosure, an OML framework for CVAE-architecture LIC is implemented by configuring a computing system to learn, from the multiple training tasks of compression with different RD tradeoff λs, a set of task-general meta parameters that are controlled by a few meta-control variables Λ. Such meta parameters play a role of learning a mapping between the meta-control variables Λ and the compression effect of using different RD tradeoffs λs. Then for a specific test datum, only the few meta-control variables Λ need to be adaptively determined and transmitted on the fly to an encoder and a decoder of an image compression process, to accommodate the current compression need for the current test datum.

In other words, the online learning aspect of the framework configures one or more processors of a computing system to make use of the ground-truth in an encoder to tune the compression process for each particular test datum, which helps to minimize the training-to-test mismatch. The meta-learning mechanism enables effective adaptation for online learning in LIC.

Subsequently, parameterization of a CVAE-based meta-LIC architecture is described, followed by parameterization of an online CVAE-based meta-LIC architecture, and parameterization of an online CVAE-based meta-LIC architecture with parallelized context estimation.

Assume that some tasks of LIC with different λs are drawn from a task distribution T. At meta-training time, we observe M tasks with λ₁, . . . , λ_{M}. At test time, we have a new task with an arbitrary target λₜ. By learning from the training tasks, meta-learning-based LIC aims to optimize the RD loss for λₜ, without regular large-scale training for λₜ.

Let Ø={Øᵢ^{k}} include all the parameters shared across different tasks. Let L(dⱼ, λⱼ, Ø) represent the average loss on the dataset dⱼ for RD tradeoff λⱼ. The MAML method learns an initial set of parameters Ø based on all the training tasks, by solving the optimization problem according to Equation 3 as follows:

$${min}_{∅} {\sum }_{j = 1}^{M} L ( {d}_{j} , {λ}_{j} , ∅ - α Δ {\hat{L}}_{j} ( ∅ , {λ}_{j} ) )$$

Where Δ\hat{L}ⱼ (Ø, λⱼ) is the inner gradient computed based on a small mini-batch of dataset dⱼ, and α is the step size for updating model parameters. Then at meta-test time, L(dₜ, λₜ, Ø) can be minimized by performing a few steps of gradient descent from Ø using new task data dₜ. In the context of online LIC, the current task is to compress the test input image x to yield dₜ=x.

However, updating model parameters Ø based on a single test datum is highly unstable. Moreover, the model updates need to be transferred to the decoder for reconstruction, which is prohibitively expensive. Therefore, example embodiments of the present disclosure provide an online CVAE-based meta-LIC architecture, wherein, at meta-test time, instead of updating model parameters Ø, a computing system minimizes L(dₜ, λₜ, Ø) by performing gradient descent over the meta-control variables A according to Equation 4 as follows:

λₜ^{k}=λₜ^{k}−γΔ_{λ}_{ₜ}_{^{k}}L(dₜ,λₜ,Ø), for λₜ^{k}∈Λ

γ is the step size for updating the meta-control variables, and Δ_{λ}_{ₜ}_{^{k}}L(dₜ, λₜ, Ø) is the partial gradient of L(dₜ, λₜ, Ø) against a variable λₜ^{k} in Λ. λₜ^{k} are initialized as λₜ. The direct SGD is used to find a better set of meta-control variable Λ* than the original λₜ, so that a better RD loss L(dₜ, Λ*, Ø) can be obtained. Note that unlike the original variable-rate LIC where λₜ is the same across all layers where the meta-control parameters influence the conditioned generation process, the online meta-LIC has a different λₜ^{k} for each k-th meta-controlled layer learned through online SGD.

Through meta training, the relationship between the conditional hyperparameters λ and the loss L(dₜ, λ, Ø) has been established by the CVAE network. Therefore, holding fixed input data dₜ and network Ø, a computing system can fine tune λ to reduce L(dₜ, λ, Ø) for the current input dₜ.

Furthermore, the autoregressive context model has good RD performance but is slow in computation, due to the sequential scan order. To alleviate this, example embodiments of the present disclosure further provide a parallelized context computation method for an online CVAE-based meta-LIC architecture, e.g., the two-pass checkerboard context calculation proposed by He, et al. Since OML requires multiple iterations at an encoder, parallel context estimation substantially improves computational time in practice.

Subsequently, learning processes of a CVAE-based meta-LIC architecture are described.

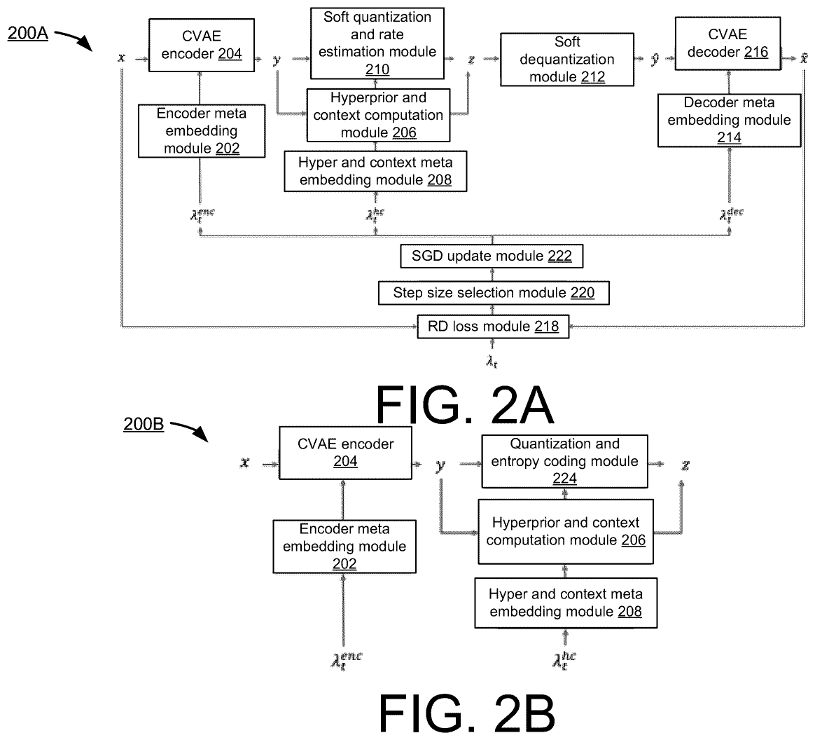

FIGS. 2A and 2B illustrate flow diagrams of an encoder-side learning process according to example embodiments of the present disclosure for a variable-rate meta-LIC based on parallel context estimation. The encoder-side learning process includes two stages, an online training stage as illustrated 200A in FIG. 2A, and an online test stage 200B as illustrated in FIG. 2B.

As FIG. 2A illustrates, in an online training stage, given an input image x, and a set of meta-control parameters λₜ^{enc}, an encoder meta embedding module 202 configures one or more processors of a computing system to compute a first training conditional meta embedded feature based on the meta-control parameters λₜ^{enc}. Based on the first training conditional meta embedded feature and the input x, a CVAE encoder 204 configures one or more processors of a computing system to compute a training latent representation y.

Then, a hyperprior and context computation module 206 configures one or more processors of a computing system to receive y and compute statistical measures describing the training latent representation y. The training latent representation y may be modeled with a predetermined distribution, such as a Gaussian distribution convolved with a unit uniform distribution. In this case, statistical measures describing the training latent representation y may include mean and scale parameters thereof. The hyperprior and context computation module 206 also configures one or more processors of a computing system to receive a second training conditional meta embedded feature. The second training conditional meta embedded feature is computed by one or more processors of a computing system configured by a hyper and context meta embedding module 208 based on a meta-control variable λₜ^{hc}. A soft quantization and rate estimation module 210 configures one or more processors of a computing system to use the statistical measures to compute an encoded bitstream z and an estimated rate loss R(z). Then, a soft dequantization module 212 configures one or more processors of a computing system to compute a decoded training latent ŷ. A decoder meta embedding module 214 configures one or more processors of a computing system to, given a set of meta-control variables λₜ^{dec}, compute a third training conditional meta embedded feature, which is passed together with the decoded training latent ŷ to a CVAE decoder 216. The CVAE decoder 216 configures one or more processors of one or more processors of a computing system to compute a reconstructed \hat{x}.

Based on the input x and the reconstructed \hat{x}, an RD loss module 218 configures one or more processors of a computing system to compute an updated RD loss L(x, \hat{x}, λₜ)=λₜD(x, \hat{x})+R (z) with the target tradeoff hyperparameter λₜ (where D(x, g_{θ}(z, λ)) is a distortion loss as described with reference to Equation 2 above). Based on the updated RD loss, a step size selection module 220 configures one or more processors of a computing system to determine the set of step sizes s^{enc}, s_{hc}, s^{dec} for updating a set of meta-control variables λₜ^{enc}, λₜ^{hc}, λₜ^{dec}, respectively. Based on the step sizes and the updated RD loss, an SGD update module 222 configures one or more processors of the computing system to compute a direct SGD to update the meta-control variables λₜ^{enc}, λₜ^{hc}, λₜ^{dec} according to Equations 5, 6, and 7 as follows:

λₜ^{enc,k}=λₜ^{enc,k}−s^{enc,k}Δ_{λ}_{ₜ}_{^{enc,k}}L(x,\hat{x},λₜ), for λₜ^{enc,k}∈λₜ^{enc}

λₜ^{hc,k}=λₜ^{hc,k}−s^{hc,k}Δ_{λ}_{ₜ}_{^{hc,k}}L(x,\hat{x},λₜ) for λₜ^{hc,k}∈λₜ^{hc}

λₜ^{dec,k}=λₜ^{dec,k}−s^{dec,k}Δ_{λ}_{ₜ}_{^{dec,k}}L(x,\hat{x},λₜ) for λₜ^{dec,k}∈λₜ^{dec}

Thereafter, the computing system completes an iteration of the online training process and can start another iteration. After a total number of O online iterations, one or more processors of a computing system are configured to store the optimized λₜ^{enc}, λₜ^{hc}, λₜ^{dec} with minimum RD loss L(x, \hat{x}, λₜ) as the final meta-control variables.

According to some embodiments, the initial values of all variables in λₜ^{enc}, λₜ^{hc}, λₜ^{dec} are set as the target tradeoff λₜ.

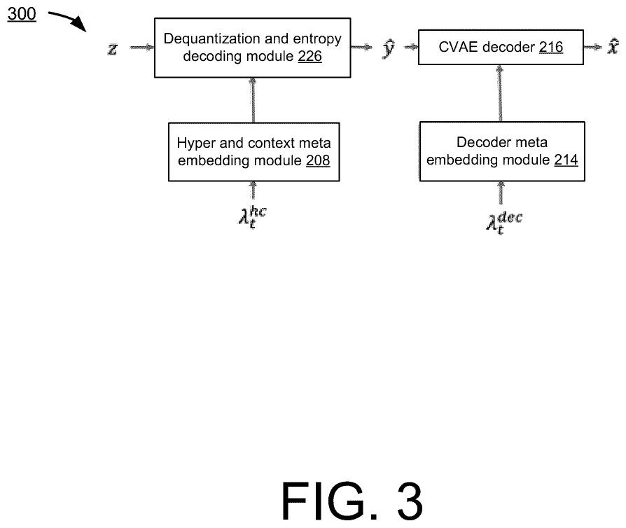

Then, as FIG. 2B illustrates, in an online test stage, the input image x is passed to the CVAE encoder 204, configuring one or more processors of a computing system to compute the latent representation y (non-training) based on the input image x and a first conditional meta embedded feature (non-training). The first conditional meta embedded feature is computed by the one or more processors based on the optimized meta-control variables λₜ^{enc}, as configured by the encoder meta embedding module 202. Then, y is passed through the hyperprior and context computation module 206, configuring one or more processors of a computing system to compute statistical measures describing the latent representation y (non-training) based on a second conditional meta embedded feature (non-training). The second conditional meta embedded feature is computed by the one or more processors based on the optimized meta-control variables λₜ^{hc}, as configured by the hyper and context meta embedding module 208. The statistical measures are used by a quantization and entropy coding module 224 to configure one or more processors of a computing system to compute an encoded bitstream z that is transmitted to a decoder as illustrated by FIG. 3. z represents an encoded bitstream of the latent representation y (non-training) after true hard quantization, and an encoded bitstream of statistical measures which describe y for reference at a decoder. The optimized meta-control variables λₜ^{hc} and λₜ^{dec} are also transmitted in the encoded bitstream z to the decoder. The optimized meta-control variables λₜ^{enc} need not be transmitted in the encoded bitstream.

FIG. 3 illustrates a flow diagram of a decoder-side test stage 300 workflow according to example embodiments of the present disclosure. After receiving the transmitted encoded bitstream z and the meta-control variables λₜ^{hc} and λₜ^{dec}, a dequantization and entropy decoding module 226 configures one or more processors of a computing system to generate a decoded latent ŷ (non-training) based on a second conditional meta embedded feature (non-training) and based on statistical measures transmitted in the encoded bitstream z. The second conditional meta embedded feature is computed by the hyper and context meta embedding module 208 based on the received meta-control variable λₜ^{hc}. The decoded latent ŷ is then passed to the CVAE decoder 216, which configures one or more processors of a computing system to compute a reconstructed \hat{x} based on a third conditional meta embedded feature (non-training). The third conditional meta embedded feature is computed by one or more processors of a computing system based on the received meta-control variable λₜ^{dec}, as configured by the decoder meta embedding module 214.

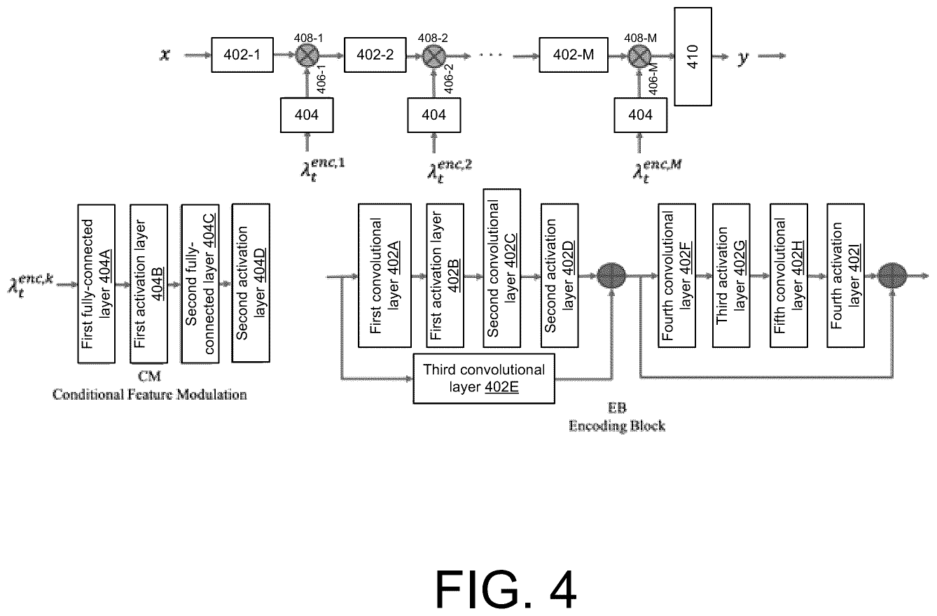

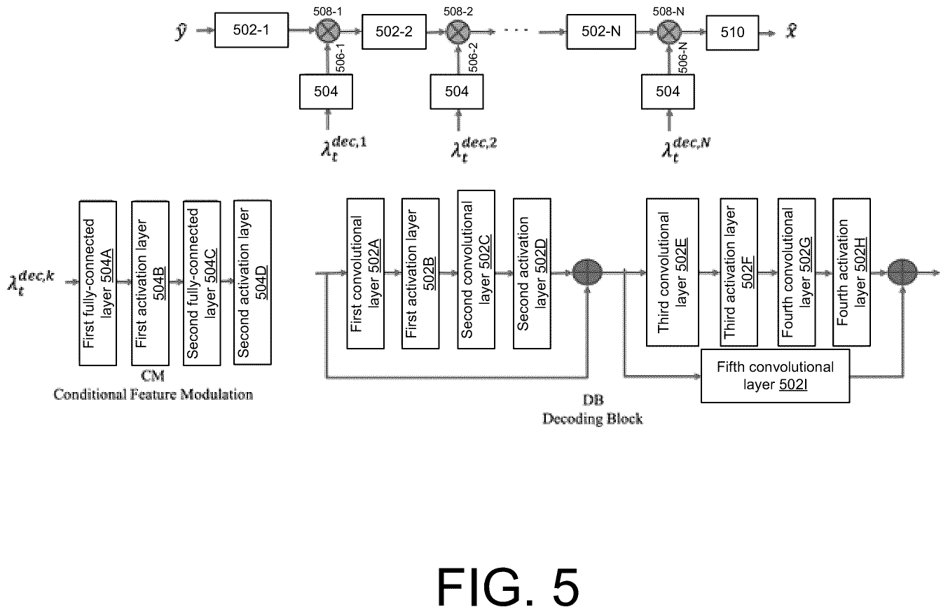

FIG. 4 illustrates a CVAE encoder 204 having inputs for optimized meta-control variables according to example embodiments of the present disclosure, and FIG. 5 illustrates a CVAE decoder 216 having inputs for optimized meta-control variables according to example embodiments of the present disclosure.

The CVAE encoder 204 includes M encoding blocks (“EBs”) 402-1, 402-2, . . . , 402-M, each EB including multiple convolutional layers, where each convolutional layer can output to an activation layer. The CVAE decoder 216 includes N decoding blocks (“DBs”) 502-1, 502-2, . . . , 502-N, each DB including multiple convolutional layers, where each convolutional layer can output to an activation layer.

By way of example, convolutional layers can include 3×3 convolution filters, having a stride of 1, 2, or more, and can configure one or more processors of a computing system to apply a convolution filter to an input to output an activation map. Convolutional layers can further include a shuffling operation (such as “Pixelshuffle”) as described by Shi, et al.), which rearranges picture data across multiple channels of a tensor to increase spatial resolution of a picture.

Activation layers can configure one or more processors of a computing system to receive an activation map as input and apply a function to the activation map to output returned values of the function. An activation layer can include a rectified linear unit (“ReLU”), which applies a ramp function to an activation map (which, by way of example, configures one or more processors of a computing system to return 0 for negative inputs and return the input itself for non-negative inputs), or can include a LeakyReLU, which applies a modified ramp function to an activation map, configuring one or more processors of a computing system to return the input multiplied by a parameter smaller than 1 for negative inputs, and return the input itself for non-negative inputs.

An activation layer can include a generalized divisive normalization (“GDN”) layer, which applies a generalized function having multiple trainable parameters to an activation map, where the generalized function can be a linear function, a piecewise sigmoidal function, a piecewise exponential function, or various other functions depending on the values of the trainable parameters. An activation layer can include an inverse GDN (“IGDN”) layer, which applies the reverse function of a GDN layer.

Each EB and each DB can further include one or more skip connections, where a skip connection may or may not include a convolutional layer. The skip connection causes an input to bypass other convolutional layers and activation layers, ultimately adding this input to the output of the bypassed convolutional layer-activation layer blocks.

By way of example, FIG. 4 illustrates an EB in which an input picture is input to a first convolutional layer 402A outputting to a first activation layer 402B outputting to a second convolutional layer 402C outputting to a second activation layer 402D, an output of the second activation layer 402D being added, in a first addition operation, to an output of a first skip connection in which the input picture bypasses 402A, 402B, 402C, and 402D, and is input to a third convolutional layer 402E. Output of the first addition operation is input to a fourth convolutional layer 402F outputting to a third activation layer 402G outputting to a fifth convolutional layer 402H outputting to a fourth activation layer 402I, an output of the fourth activation layer 402I being added, in a second addition operation, to an output of a second skip connection in which output of the first addition operation bypasses 402F, 402G, 402H, and 402I.

By way of example, the first convolutional layer 402A includes a 3×3 convolution filter having a stride 2; the second convolutional layer 402C, the fourth convolutional layer 402F, and the fifth convolutional layer 402H each includes a 3×3 convolution filter; and the third convolutional layer 402E includes a 1×1 convolution filter having a stride 2. By way of example, the first activation layer 402B, the third activation layer 402G, and the fourth activation layer 402I each includes a LeakyReLU, and the second activation layer 402D includes a GDN.

By way of example, FIG. 5 illustrates a DB in which an input picture is input to a first convolutional layer 502A outputting to a first activation layer 502B outputting to a second convolutional layer 502C outputting to a second activation layer 502D, an output of the second activation layer 502D being added, in a first addition operation, to an output of a first skip connection in which the input picture bypasses 502A, 502B, 502C, and 502D. Output of the first addition operation is input to a third convolutional layer 502E outputting to a third activation layer 502F outputting to a fourth convolutional layer 502G outputting to a fourth activation layer 502H, an output of the fourth activation layer 502H being added, in a second addition operation, to an output of a second skip connection in which output of the first addition operation bypasses 502E, 502F, 502G, and 502H, and is input to a fifth convolutional layer 502I.

By way of example, the first convolutional layer 502A, the second convolutional layer 502C, and the fourth convolutional layer 502G each includes a 3×3 convolution filter; and the third convolutional layer 502E and the fifth convolutional layer 502I each includes a 3×3 convolution filter and a Pixelshuffle operation at an upscale factor of 2. By way of example, the first activation layer 502B, the second activation layer 502D, and the third activation layer 502F each includes a LeakyReLU, and the fourth activation layer 502H includes an IGDN.

The CVAE encoder 204 further includes M conditional feature modulation inputs 406-1, 406-2, . . . , 406-M, each conditional feature modulation input configuring one or more processors of a computing system to receive a first conditional meta embedded feature (training or otherwise) from a conditional feature modulation model 404. A conditional feature modulation model 404 can be part of the encoder meta embedding module 202, and can configure one or more processors of a computing system to receive a variable λₜ^{enc,1}, λₜ^{enc,2}, . . . , or λₜ^{enc,M} of the optimized meta-control variables λₜ^{enc}, input the variable into a fully-connected layer having an output to an activation layer, and outputting a first conditional meta embedded feature from an activation layer. Each conditional feature modulation input configures one or more processors of a computing system to perform a multiplication operation 408-1, 408-2, . . . , 408-M between a first conditional meta embedded feature and a respective output of one of EBs 402-1, 402-2, . . . , 402-M.

The CVAE encoder 204 further includes a last convolution layer 410, which configures one or more processors of a computing system to receive an output of the multiplication between output of the EB 402-M and a first conditional meta embedded feature, apply a convolution filter to the output, and output a latent representation y (training or otherwise) as described above with reference to FIG. 2A. By way of example, the last convolution layer 410 can include a 3×3 convolution filter.

The CVAE decoder 216 further includes N conditional feature modulation inputs 506-1, 506-2, . . . , 506-N, each conditional feature modulation input configuring one or more processors of a computing system to receive a third conditional meta embedded feature (training or otherwise) from a conditional feature modulation model 504. A conditional feature modulation model 504 can be part of the decoder meta embedding module 214, and can configure one or more processors of a computing system to receive a variable λₜ^{dec,1}, λₜ^{dec,2}, . . . , or λₜ^{dec,N} of the optimized meta-control variables λₜ^{dec}, input the variable into a fully-connected layer having an output to an activation layer, and outputting a third conditional meta embedded feature from an activation layer. Each conditional feature modulation input 506-1, 506-2, . . . , 506-N configures one or more processors of a computing system to perform a multiplication operation 508-1, 508-2, . . . , 508-N between a third conditional meta embedded feature and a respective output of one of DBs 502-1, 502-2, . . . , 502-N.

The CVAE decoder 216 further includes a reconstruction block (“RB”) 510, which configures one or more processors of a computing system to receive an output of the multiplication between output of the DB 502-N and a third conditional meta embedded feature, and compute and output a reconstructed \hat{x} as described above with reference to FIG. 2A.

By way of example, in a conditional feature modulation model 404, a variable λₜ^{enc,1}, λₜ^{enc,2}, . . . , or λₜ^{enc,M} is input into a first fully-connected layer 404A outputting to a first activation layer 404B outputting to a second fully-connected layer 404C outputting to a second activation layer 404D. Outputs 1, 2, . . . , M of a last activation layer of the conditional feature modulation model 404 are input at conditional feature modulation inputs 1, 2, . . . , M of a CVAE encoder 204.

By way of example, the first activation layer 404B and the second activation layer 404D each includes a ReLU.

By way of example, in a conditional feature modulation model 504, a variable λₜ^{dec,1}, λₜ^{dec,2}, . . . , or λₜ^{dec,N} is input into a first fully-connected layer 504A outputting to a first activation layer 504B outputting to a second fully-connected layer 504C outputting to a second activation layer 504D. Outputs 1, 2, . . . , N of a last activation layer of the conditional feature modulation model 504 are input at conditional feature modulation inputs 1, 2, . . . , N of a CVAE decoder 216.

By way of example, the first activation layer 504B and the second activation layer 504D each includes a ReLU.

These encoder and decoder architectures should not be understood as limiting the scope of the present disclosure, as the above framework of the online meta learning can be flexibly applied to various underlying CVAE model structures.

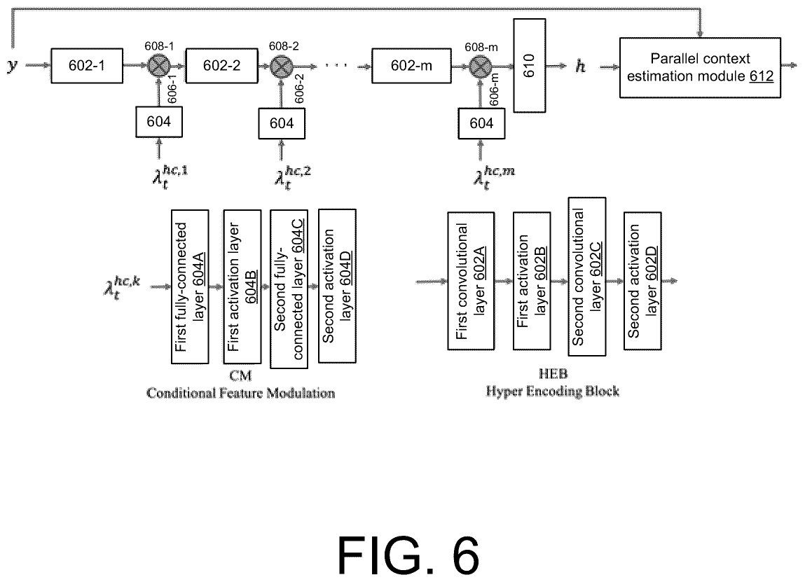

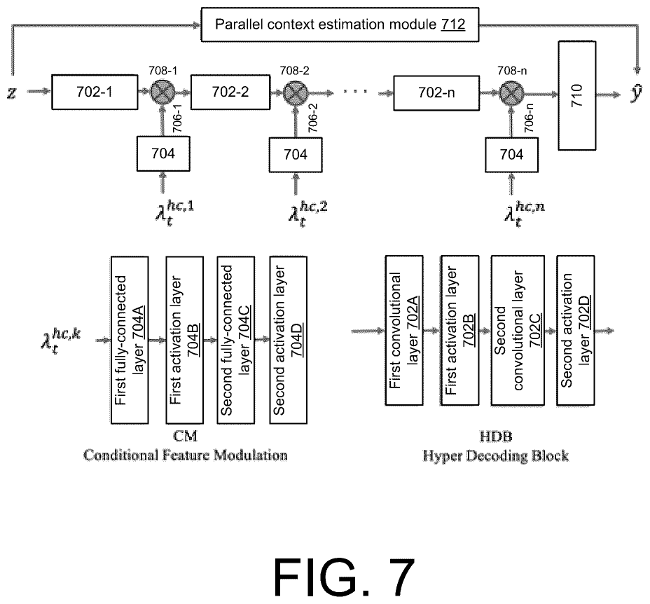

FIG. 6 illustrates a hyperprior and context computation module 206 of a quantization and entropy coding module 224 as illustrated in FIG. 2B according to example embodiments of the present disclosure, and FIG. 7 illustrates a hyperprior and context computation module of a quantization and entropy decoding module 226 as illustrated in FIG. 3 according to example embodiments of the present disclosure. (In FIG. 3, the hyperprior and context computation module can be an element of the dequantization and entropy decoding module 226.) The hyperprior and context computation module can include any network structures configured to compute statistical measures describing the latent representation y (non-training).

A quantization and entropy coding module 224 includes m hyper encoding blocks (“HEBs”) 602-1, 602-2, . . . , 602-m, each HEB including multiple convolutional layers, where each convolutional layer can output to an activation layer. The hyperprior and context computation module of a quantization and entropy decoding module 226 includes n hyper decoding blocks (“HDBs”) 702-1, 702-2, . . . , 702-n, each HDB including multiple convolutional layers, where each convolutional layer can output to an activation layer. It should be understood that m and n need not be the same values as M and N illustrated in FIGS. 4 and 5 above.

By way of example, FIG. 6 illustrates an HEB in which an input latent representation y (non-training) is input to a first convolutional layer 602A outputting to a first activation layer 602B outputting to a second convolutional layer 602C outputting to a second activation layer 602D.

By way of example, the first convolutional layer 602A includes a 3×3 convolution filter having a stride 2, and the second convolutional layer 602C includes a 3×3 convolution filter. By way of example, the first activation layer 602B and the second activation layer 602D each includes a LeakyReLU.

By way of example, FIG. 7 illustrates an HDB in which an input encoded bitstream z is input to a first convolutional layer 702A outputting to a first activation layer 702B outputting to a second convolutional layer 702C outputting to a second activation layer 702D.

By way of example, the first convolutional layer 702A includes a 3×3 convolution filter, and the second convolutional layer 702C includes a 3×3 convolution filter and a Pixelshuffle operation at an upscale factor of 2. By way of example, the first activation layer 702B and the second activation layer 702D each includes a LeakyReLU.

A quantization and entropy coding module 224 further includes m conditional feature modulation inputs 606-1, 606-2, . . . , 606-m, each conditional feature modulation input configuring one or more processors of a computing system to receive a second conditional meta embedded feature (non-training) from a conditional feature modulation model 604. A conditional feature modulation model 604 can be part of the hyper and context meta embedding module 208, and can configure one or more processors of a computing system to receive a variable λₜ^{hc,1}, λₜ^{hc,2}, . . . , or λₜ^{hc,m} of the optimized meta-control variables λₜ^{hc}, input the variable into a fully-connected layer having an output to an activation layer, and outputting a second conditional meta embedded feature from an activation layer. Each conditional feature modulation input 606-1, 606-2, . . . , 606-m configures one or more processors of a computing system to perform a multiplication operation 608-1, 608-2, . . . , 608-m between a second conditional meta embedded feature and a respective output of one of HEBs 602-1, 602-2, . . . , 602-m.

A quantization and entropy coding module 224 further includes a last convolution layer 610, which configures one or more processors of a computing system to receive an output of the multiplication between output of the HEB 602-m and a second conditional meta embedded feature, apply a convolution filter to the output, and output a hyperprior h of the latent representation y. By way of example, the last convolution layer 610 can include a 3×3 convolution filter.

A quantization and entropy decoding module 226 further includes n conditional feature modulation inputs 706-1, 706-2, . . . , 706-n, each conditional feature modulation input configuring one or more processors of a computing system to receive a second conditional meta embedded feature (non-training) from a conditional feature modulation model 704. A conditional feature modulation model 704 can be part of the hyperprior and context meta embedding module 208, and can configure one or more processors of a computing system to receive a variable λₜ^{hc,1}, λₜ^{hc,2}, . . . , or λₜ^{h,n} of the optimized meta-control variables λₜ^{hc}, input the variable into a fully-connected layer having an output to an activation layer, and outputting a second conditional meta embedded feature from an activation layer. Each conditional feature modulation input 706-1, 706-2, . . . , 706-n configures one or more processors of a computing system to perform a multiplication operation 708-1, 708-2, . . . , 708-n between a second conditional meta embedded feature and a respective output of one of HDBs 702-1, 702-2, . . . , 702-n.

The hyperprior and context computation module of a quantization and entropy decoding module 226 further includes a last convolution layer 710, which configures one or more processors of a computing system to receive an output of the multiplication between output of the HDB 702-n and a second conditional meta embedded feature, apply a convolution filter to the output, and output a decoded latent ŷ as described above with reference to the dequantization and entropy decoding module 226 of FIG. 3. By way of example, the last convolution layer 710 can include a 3×3 convolution filter.

By way of example, in a conditional feature modulation model 604, a variable λₜ^{hc,1}, λₜ^{hc,2}, . . . , or λₜ^{hc,m} is input into a first fully-connected layer 604A outputting to a first activation layer 604B outputting to a second fully-connected layer 604C outputting to a second activation layer 604D. Outputs 1, 2, . . . , m of a last activation layer of the conditional feature modulation model 604 are respectively input at conditional feature modulation inputs 606-1, 606-2, . . . , 606-m of a quantization and entropy coding module 224.

By way of example, the first activation layer 604B and the second activation layer 604D each includes a ReLU.

By way of example, in a conditional feature modulation model 704, a variable λₜ^{hc,1}, λₜ^{hc,2}, . . . , or λₜ^{hc,n} is input into a first fully-connected layer 704A outputting to a first activation layer 704B outputting to a second fully-connected layer 704C outputting to a second activation layer 704D. Outputs 1, 2, . . . , n of a last activation layer of the conditional feature modulation model 704 are input at conditional feature modulation inputs 1, 2, . . . , n of a quantization and entropy decoding module 226.

By way of example, the first activation layer 704B and the second activation layer 704D each includes a ReLU.

Furthermore, FIG. 6 illustrates the quantization and entropy coding module 224 further including a parallel context estimation module 612, and FIG. 7 illustrates the quantization and entropy decoding module 226 further including a parallel context estimation module 712. Parallel context estimation modules 612 and 712 can each, by way of example, be implemented in accordance with the two-pass checkerboard context calculation proposed by He, et al., as described above.

Parallel context estimation module 612 configures one or more processors of a computing system to receive a hyperprior h of the latent representation y as output from the last convolutional layer 610, and receive the latent representation y from a skip connection of the quantization and entropy coding module 224 and output a statistical measure describing the latent representation y based on the hyperprior h, the latent representationy, and a context model. Parallel context estimation module 712, included in a skip connection of the quantization and entropy decoding module 226, configures one or more processors of a computing system to receive an encoded bitstream z from the skip connection of the quantization and entropy decoding module 226 and output a statistical measure describing a decoded latent ŷ based on decoding the encoded bitstream z and based on a context model. A decoded latent ŷ output by the last convolutional layer 710 as described above is combined with a statistical measure describing the decoded latent ŷ and passed to the CVAE decoder 216.

The CVAE LIC enables optimizing for multiple compression rates where DNN-based LICs cannot. Compression with each target can be treated as a task, and, by observing training tasks of multiple compression rates, meta learning enables fast generalization to a new test compression rate, which is analogous to variable-rate LIC. The CVAE LIC also adapts online learning to LIC, since the target is to encode and recover the input image itself, and the encoder has the ground-truth input at test time. Furthermore, since context estimation cannot be dropped from a LIC without causing significant performance drop, the CVAE LIC adopts parallel context computation as a replacement for sequential autoregressive context computation.

Persons skilled in the art will appreciate that all of the above aspects of the present disclosure may be implemented concurrently in any combination thereof, and all aspects of the present disclosure may be implemented in combination as yet another embodiment of the present disclosure.

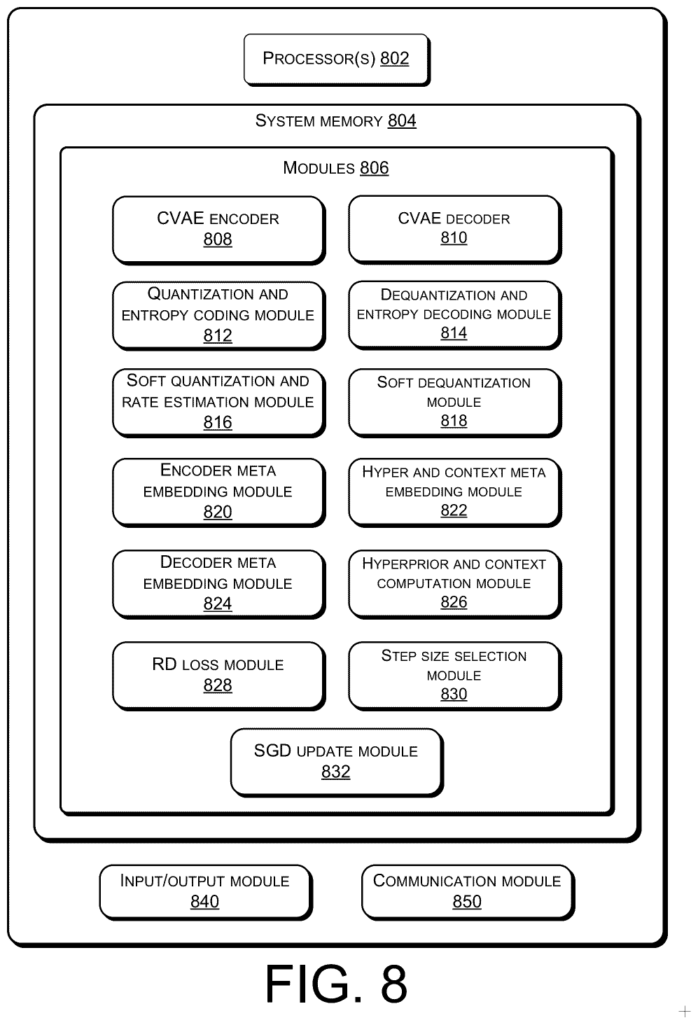

FIG. 8 illustrates an example system 800 for implementing the processes and methods described above for implementing an online CVAE-based meta-LIC architecture.

The techniques and mechanisms described herein may be implemented by multiple instances of the system 800 as well as by any other computing device, system, and/or environment. The system 800 shown in FIG. 8 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 800 may include one or more processors 802 and system memory 804 communicatively coupled to the processor(s) 802. The processor(s) 802 may execute one or more modules and/or processes to cause the processor(s) 802 to perform a variety of functions. In some embodiments, the processor(s) 802 may include a central processing unit (“CPU”), a graphics processing unit (“GPU”), both CPU and GPU, or other processing units or components known in the art. Additionally, each of the processor(s) 802 may possess its own local memory, which also may store program modules, program data, and/or one or more operating systems.

Depending on the exact configuration and type of the system 800, the system memory 804 may be volatile, such as RAM, non-volatile, such as ROM, flash memory, miniature hard drive, memory card, and the like, or some combination thereof. The system memory 804 may include one or more computer-executable modules 806 that are executable by the processor(s) 802.

The modules 806 may include, but are not limited to, a CVAE encoder module 808, a CVAE decoder module 810, a quantization and entropy coding module 812, a dequantization and entropy decoding module 814, a soft quantization and rate estimation module 816, a soft dequantization module 818, an encoder meta embedding module 820, a hyper and context meta embedding module 822, a decoder meta embedding submodule 824, a hyperprior and context computation module 826, an RD loss module 828, a step size selection module 830, and an SGD update module 832 as described above with reference to FIGS. 2A, 2B, and 3.

The quantization and entropy coding module 812 may be executable by the processor(s) 802 to perform picture coding by any of the techniques and processes described above, such as an image compression process 100 of FIG. 1.

The dequantization and entropy decoding module 814 may be executable by the processor(s) 802 to perform picture coding by any of the techniques and processes described above, such as an image compression process 100 of FIG. 1.

The system 800 may additionally include an input/output (I/O) interface 840 for receiving input picture data and bitstream data, and for outputting decoded pictures to a display, an image processor, a learning model, and the like. The system 800 may also include a communication module 850 allowing the system 800 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transitory computer-readable storage media that, when executed by one or more processors, may perform operations described above with reference to FIGS. 1-7. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
computing, by one or more processors of a computing system, a first conditional meta embedded feature based on inputting a first set of optimized meta-control variables into a first modulation learning model;
tuning, by the one or more processors, parameters of an auto-encoder based on the first conditional meta embedding feature; and
computing, by the one or more processors configured by the auto-encoder, a latent representation of an input picture.

2. The method of claim 1, further comprising:
computing, by the one or more processors, a second conditional meta embedded feature based on inputting a second set of optimized meta-control variables into a second modulation learning model; and
computing, by the one or more processors, a statistical measure describing the latent representation based on the second conditional meta embedded feature.

3. The method of claim 2, further comprising:
coding, by the one or more processors, the latent representation as a coded picture based on the statistical measure; and
transmitting, by the one or more processors, the coded picture and the second set of optimized meta-control variables in a bitstream.

4. The method of claim 2, wherein the first modulation learning model and the second modulation learning model each comprises a respective plurality of fully-connected layers and a respective plurality of activation layers.

5. The method of claim 3, further comprising:
transmitting, by the one or more processors, a third set of optimized meta-control variables in a bitstream;
wherein the first, second, and third sets of optimized meta-control variables are each learned by optimizing a rate distortion (RD) loss during online meta-learning by stochastic gradient descent (SGD).

6. The method of claim 1, wherein tuning parameters of the auto-encoder based on the first conditional meta embedding feature comprises receiving, by the one or more processors, the first conditional meta embedding feature at a plurality of conditional feature modulation inputs, wherein each conditional feature modulation input corresponds to a respective encoding block of the auto-encoder.

7. The method of claim 6, wherein tuning parameters of the auto-encoder based on the first conditional meta embedding feature further comprises computing, by the one or more processors, a multiplication operation between the conditional meta embedding feature and an output of a respective encoding block of the auto-encoder.

8. A method comprising:
computing, by the one or more processors, a training latent representation based on a first training conditional meta embedded feature and an input training picture;
computing, by the one or more processors, a decoded training latent based on a second training conditional meta embedded feature; and
computing, by the one or more processors, a reconstructed picture based on the decoded training latent and a third training conditional meta embedded feature;
wherein the first, second, and third training conditional meta embedded features are respectively derived from a first, second, and third set of optimized meta-control variables each learned by optimizing a rate distortion (RD) loss during online meta-learning by stochastic gradient descent (SGD).

9. The method of claim 8, further comprising:
determining, by the one or more processors, a step size for updating a meta-control variable based on the RD loss; and
learning, by the one or more processors, the meta-control variable based on a stochastic gradient descent (SGD) computed from the step size and the rate distortion loss.

10. The method of claim 8, further comprising:
computing, by the one or more processors, training statistical measures describing the training latent representation;
coding, by the one or more processors, a coded training picture based on the training statistical measures; and
computing, by the one or more processors, a rate loss based on the training statistical measures.

11. The method of claim 10, further comprising:
computing, by the one or more processors, a distortion loss based on the input training picture and the reconstructed picture; and
computing, by the one or more processors, an updated RD loss based on the estimated rate loss and the distortion loss.

12. The method of claim 10, wherein the training latent representation and the training statistical measures are each transmitted in a bitstream, the decoded training latent is derived from the training latent representation and the training statistical measures transmitted in the bitstream, and the rate loss is based on a bitrate of the bitstream.

13. The method of claim 11, wherein the first, second, and third set of optimized meta-control variables are each updated based on the updated RD loss during the online meta-learning.

14. A method comprising:
reading, by one or more processors of a computing system, a coded picture and a first set of optimized meta-control variables from a bitstream;
computing, by one or more processors of a computing system, a first conditional meta embedded feature based on inputting the first set of optimized meta-control variables into a first modulation learning model;
tuning, by the one or more processors, parameters of an entropy decoder based on the first conditional meta embedding feature; and
decoding, by the one or more processors, a decoded latent representation based on inputting the coded picture into the entropy decoder.

15. The method of claim 14, further comprising:
reading, by the one or more processors, a second set of optimized meta-control variables from the bitstream;
computing, by the one or more processors, a second conditional meta embedded feature based on inputting the second set of optimized meta-control variables into a second modulation learning model; and
tuning, by the one or more processors, parameters of an auto-decoder based on the second conditional meta embedded feature.

16. The method of claim 15, further comprising:
computing, by the one or more processors, a reconstructed picture by inputting the decoded latent representation into the auto-decoder.

17. The method of claim 15, wherein the first modulation learning model and the second modulation learning model each comprises a respective plurality of fully-connected layers and a respective plurality of activation layers.

18. The method of claim 15, wherein tuning parameters of the entropy decoder based on the first conditional meta embedding feature comprises receiving, by the one or more processors, the first conditional meta embedding feature at a plurality of conditional feature modulation inputs, wherein each conditional feature modulation input corresponds to a respective decoding block of the entropy decoder; and
wherein tuning parameters of the auto-decoder based on the second conditional meta embedding feature comprises receiving, by the one or more processors, the second conditional meta embedding feature at a plurality of conditional feature modulation inputs, wherein each conditional feature modulation input corresponds to a respective decoding block of the auto-decoder.

19. The method of claim 18, wherein tuning parameters of the entropy decoder based on the first conditional meta embedding feature further comprises computing, by the one or more processors, a multiplication operation between the first conditional meta embedding feature and an output of a respective decoding block of the entropy decoder; and
wherein tuning parameters of the auto-decoder based on the second conditional meta embedding feature further comprises computing, by the one or more processors, a multiplication operation between the second conditional meta embedding feature and an output of a respective decoding block of the auto-decoder.

20. A non-transitory computer-readable storage medium storing a bitstream associated with one or more pictures, the bitstream comprising:
a first conditional meta embedding feature; and
a second conditional meta embedding feature;
wherein the first and second conditional meta embedded features are respectively derived from a first and second set of optimized meta-control variables each learned by optimizing a rate distortion (RD) loss during online meta-learning by stochastic gradient descent (SGD).
